(19) United States
(12) Patent Application Publication
(10) Pub. No.: US 2020/0052279 A1
(43) Pub. Date: Feb. 13, 2020

(54) METHOD OF PREPARING ENERGY STORAGE ELECTRODES

(71) Applicant: Tuqiang Chen, Albuquerque, NM (US)

(72) Inventor: Tuqiang Chen, Albuquerque, NM (US)

(21) Appl. No.: 16/102,378

(22) Filed: Aug. 13, 2018

(51) Int. Cl. H01M 4/04; H01M 4/525; H01M 4/74; H01M 10/0525; H01G 11/86

(52) U.S. Cl. CPC H01M 4/0433; H01M 4/525; H01G 11/86; H01M 4/0471; H01M 10/0525; H01M 4/74

(57) ABSTRACT

An energy storage electrode is formed by heat-pressing preformed electrode membranes into the pore structures of a metal mesh current collector without use of any solvents. The electrodes are utilized primarily for Li-ion batteries, as well as supercapacitors. This solvent-free method for electrode preparation is more cost-efficient and environmentally-friendly, in comparison with the method involving preparation and casting slurries or pastes onto metal foil current collectors, where a solvent is required.

### STATEMENT REGARDING FEDERALLY SPONSORED R&D

None.

### FIELD OF INVENTION

The invention relates to a method of preparing an energy storage electrode for use in electrochemical cells incorporating such electrodes. The electrochemical cells include Li-ion batteries and supercapacitors.

### BACKGROUND OF THE INVENTION

Conventional Li-ion batteries or supercapacitors are typically two-dimensional (2-D) cells, where thick films of the anode, separator/electrolyte, and cathode are stacked, spiral wound, or folded. The electrodes (anodes or cathodes) of Li-ion, or supercapacitor cells, are of similar form and are made by similar processes on similar or identical equipment where active electrode materials in the form of powder are mixed with conductive additive and polymer binder in the presence of an organic solvent to form a slurry, which is coated on a metallic foil that functions as the current collector conducting current in and out of the cell. The electrodes are dried, slit, and assembled into 2-D cells. The processing of preparing and casting slurries onto metal foil, involves use of an organic solvent, e.g. dimethylformamide (DMF). The solvent is subsequently removed and released into the atmosphere. This process is costly and not environmental friendly. It is also time-consuming, compared with a process involving no solvents. However, it appears necessary to use a solvent when metal foil substrate is used for electrode preparation, to ensure sufficient adhesion of electrode films to metal foil.

In recent years, efforts have been made to improve performances of Li batteries and supercapacitors involving utilization of metal mesh instead of metal foil as current collectors. Chen disclosed a 3-D Li battery and supercapacitor in a U.S. patent (U.S. Pat. No. 9,905,370), where ultrafine metal mesh (UMM) was used as current collector. Thin films of electrode materials and solid state electrolytes were sequentially deposited onto the surfaces of the ultrafine metal mesh wires, forming UMM-based electrodes. The UMM-based anodes and cathodes were alternately stacked and laminated, forming mesh-based 3-D energy storage devices for better electrochemical and mechanical performance characteristics. Shi, et al. reported in a research article (Nano Energy, 2014, 6, 82-91) a flexible supercapacitor, prepared by deposition of carbon materials on stainless steel (SS) mesh, followed by assembly of a pair of mesh electrodes sandwiching a separator that is wetted with an organic electrolyte.

These mesh-based electrodes, compared with conventional foil-based electrodes, allow loading of more electrode materials for improved performance characteristics due to higher porosity of mesh. These include energy and power densities, and structural flexibility for construction of various configurations of electrochemical cells. Additionally, a mesh substrate, having pore structures of high surface area, promotes better bonding between electrode materials and the substrate. It also permits formation of an inherent, continuous body of the electrode materials from one side of the mesh to the other, which is not possible for a foil substrate where the two electrode films are separated by the foil. The novel structures of mesh may also allow an alternative, cost-efficient approach to preparation of mesh electrodes; however, conventional preparation methods involving slurries or solutions were used in Chen and Shi's disclosures.

### SUMMARY OF THE INVENTION

These and other objectives are achieved in the present invention by 1) utilizing a metal mesh as current collector, 2) making an electrode membrane by pressing electrode powder mixtures, and 3) making an energy storage electrode, primarily for use in Li-ion batteries and supercapacitors, comprising the metal mesh and the electrode membranes, with the later inherently locked into the pore structures of the mesh by heat-pressing, forming an inherently integrated component.

Accordingly, it is an object of the present invention to claim a cost-efficient and environmentally-friendly method of making a mesh electrode without using a solvent. It is another object of the present invention to disclose an energy storage electrode, comprising a flexible metal mesh current collector embedded in the electrode materials body, for Li-ion batteries and supercapacitors utilizing such electrodes for improved performance characteristics including higher energy and power densities, and structural flexibility in cell configuration designs.

In accordance with the present invention, the method for making the energy storage electrodes comprises steps of 1) mixing powder electrode materials without presence of a solvent, 2) making a free-standing or a release-film supported membrane by heat-pressing, and 3) making a mesh electrode by heat-pressing a pair of the membranes sandwiching the mesh current collector.

### BRIEF DESCRIPTION OF THE DRAWINGS

The principle of the present invention may be understood with reference to the detailed description, in conjunction with the accompanying drawings, in which:

FIG. 1 shows a cross-sectional view of a mesh electrode.

FIG. 2 shows a cross-sectional view of a press mold where electrode materials mixture is loaded in a press mold for making electrode membranes.

FIG. 3 shows a cross-sectional view of the press mold where electrode membrane is made upon pressing.

FIG. 4 shows a cross-sectional side view of a pair of heat press plates where a pair of electrode membranes sandwiching a metal mesh is being pressed for making the electrode.

FIG. 5 shows a cross-sectional side view of an apparatus consisting of a pair of heat press rollers where a pair of electrode membranes sandwiching a metal mesh is delivered and pressed to make the electrode continuously.

FIG. 6 shows a cross-sectional side view of an apparatus for continuously making electrode membranes.

FIG. 7 shows a front cross-sectional view of the feeding part of the apparatus for continuously making electrode membranes.

### DETAILED DESCRIPTION OF THE INVENTION

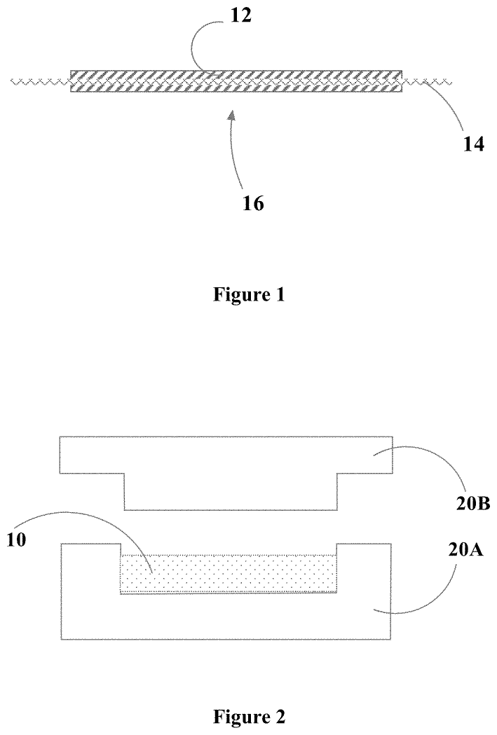

Referring now to FIG. 1 of the drawings, an energy storage electrode 16, comprises a metal mesh 14 and a pair of electrode materials membranes 12, with the membranes inherently bonded together and locked into the pore structures of the mesh by heat-pressing a pair of the membranes sandwiching the metal mesh. The mesh electrode 16 is essentially an electrode of metal mesh/wire reinforced ceramic/polymer composite, showing improved mechanical strength and increased electrode materials loading over conventional electrode using metal foil current collector. The mesh wire diameter and mesh pore/opening size may range, for example, from 10 to 100 microns, whereas the thickness of the finished electrode from 10 to 300 microns. In a particularly preferred embodiment of the invention, mesh wire diameter and mesh pore size are 25 microns and finished electrode thickness 75 microns.

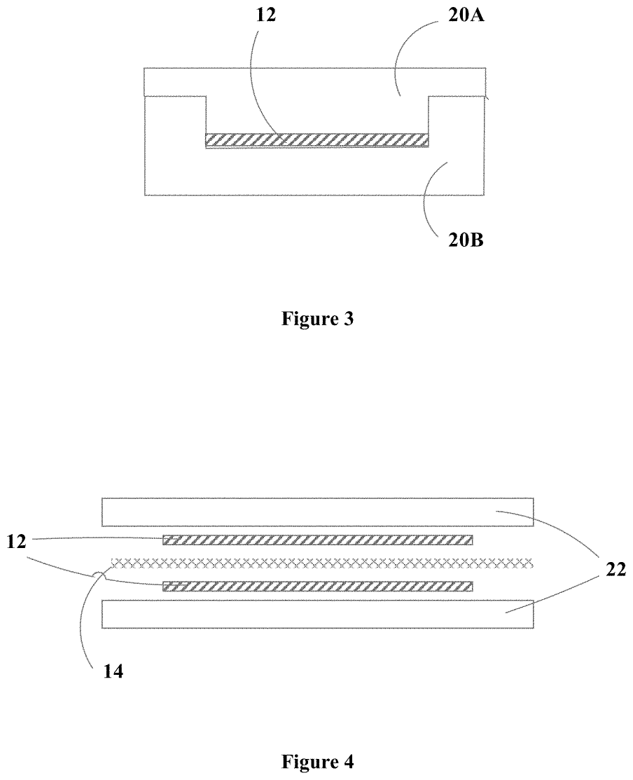

Referring to FIG. 2 and FIG. 3 of the drawings, an electrode membrane 12 is prepared by loading into mold 20A a well-mixed sample 10 consisting of powdery active material, conductive additive, and polymer binder, followed by pressing using mold 20B with or without heat. The thickness of 12 may range from 10 to 200 microns. Electrode active materials may include: a) high surface area carbon materials for supercapacitors, b) sulfur (S) for Li—S batteries, 3) Li-ion cathode materials such as LiCoO₂, LiNiO₂, LiMn₂O₄, LiFePO₄, and LiNiₓCo_{y}Mn_{z}, and 4) Li-ion anode materials such as graphite, and silicon. Conductive additives may include carbon or non-carbon conducting additives and polymer binders may include polyvinylidene fluoride (PVDF), ethylene-propylene diene (EPDM), carboxy methyl cellulose (CMC), polytetrafluoroethylene (PTFE) and sodium carboxymethyl cellulose (SBR). The temperature for the heat-pressing may range from room temperature to 400° C., and the pressure from 0 to 65 psig.

Referring to FIG. 4 of the drawings, an energy storage electrode 16 is made by heat-pressing a pair of electrode membranes 12 sandwiching a metal mesh 14 using a pair of hot-plates 22 until the pair of the membranes are bonded inherently within the framework of the mesh with desired thickness. The temperature for the heat-pressing may range from room temperature to 400° C., and the pressure from 0 to 65 psig.

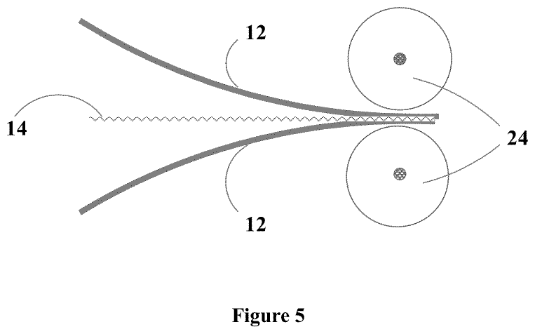

Referring to FIG. 5 of the drawings, a pair of membranes 12 sandwiching a metal mesh sheet 14 are fed continuously into a heat press apparatus consisting of a pair of rollers 24, to form mesh electrode 16, which may be collected by winding it into a roll. The pair of rollers may be replaced with a series of pairs of rollers for better preparation of the mesh-based electrodes, where the spacing between the rollers of the same pair decreases sequentially. The temperature of the rolling process may range from room temperature to 400° C.

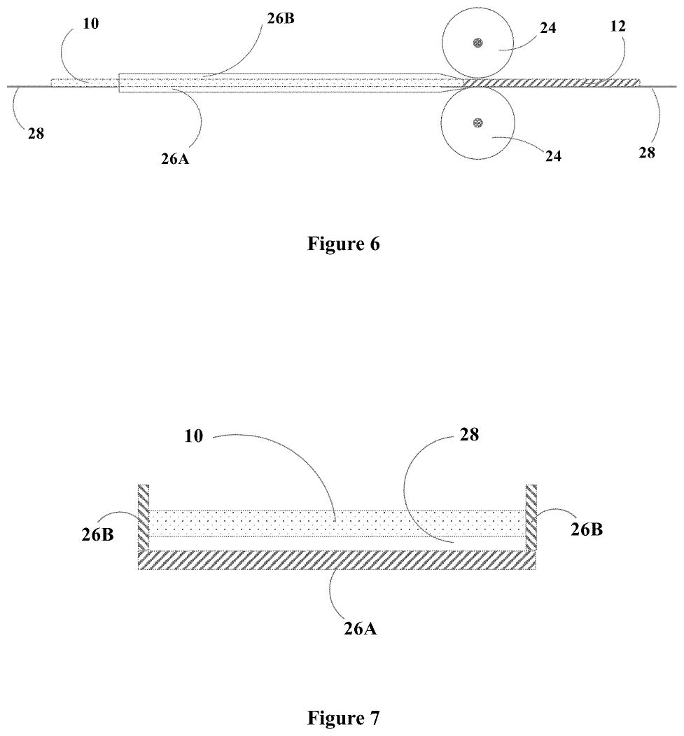

Referring to FIG. 6 and FIG. 7 of the drawings, a mixture of powder 10 is spread continuously onto a release film 28 that is supported by bottom board 26A and guided with side guard 26B. The powder mixture along with the release film is fed into a pair of rollers 24 and pressed to form membrane 12, which may be collected by winding it into a roll. The pair of rollers may be replaced with a series of pairs of rollers for better preparation of the electrode membranes, where the spacing between the rollers of the same pair decreases sequentially. The temperature of the rolling process may range from room temperature to 400° C.

The present invention discloses a method of preparing an energy storage electrode on metal mesh current collector without use of organic solvents, whereas for preparation of electrodes on metal foil, solvent is required to prepare slurries or pastes that are subsequently cast onto metal foil. These mesh-based electrodes are primarily used in Li-ion batteries and supercapacitors. In accordance with embodiments of the present invention, a metal mesh, having dimensions (for example, mesh wire diameter and pore size) ranging from several microns to several hundred microns, is utilized as a current collector, and a pair of premade electrode materials membranes, sandwiching the mesh, are heat-pressed partially into the pore structures of the metal mesh, forming a mesh electrode.

Supercapacitors, also called ultracapacitors or electrochemical double layer capacitors, as energy storage devices, use high surface area carbon as electrode materials. These include activated carbons, carbon nanotubes, graphenes, as well as pseudo-capacitance metal oxides such as RuO₂, NiO, and IrO₂. Such materials in powder form may be mixed with a polymer binder without presence of a solvent and pressed with or without heat, forming supercapacitor electrode membranes, a pair of which, sandwiching a mesh, may be pressed partially into the pores of the metal mesh substrate under pressure and heat, forming mesh-based supercapacitor electrodes without using any solvents. The relative proportions of “active materials” and polymer binder may range, for example, from 50 wt % to 95 wt % of active material, the balance being polymer binder.

Li-ion batteries, as energy storage devices, commonly use a metal oxide as cathode and a carbon material as anode. Any suitable Li-ion battery cathode materials may be used with LiCoO₂, LiNiO₂, LiMn₂O₄, LiFePO₄, or LiNiₓCo_{y}Mn_{z}, as an example. Such materials in powder form may be mixed with a conductive additive and a polymer binder without presence of a solvent and pressed with or without heat, forming Li-ion cathode membranes, a pair of which, sandwiching a mesh, may be pressed partially into the pores of the metal mesh substrate under pressure and heat, forming mesh-based Li-ion cathodes without using any solvents. The relative proportions of active material, conductive additive, and polymer binder may range, for example, from 50 wt % to 90 wt % of active material, and 0 wt % to 15 wt % of conductive additive, the balance being polymer binder.

Any suitable Li-ion anode material may be used in the invention, with graphite, or Si as an example. Such materials in powder form may be mixed with a conductive additive and a polymer binder without presence of a solvent and pressed with or without heat, forming electrode membranes, a pair of which, sandwiching a mesh, may be pressed partially into the pores of the metal mesh under pressure and heat, forming mesh-based Li-ion anodes without using any solvents. The relative proportions of active material, conductive additive, and polymer binder may range, for example, from 50 wt % to 90 wt % of active material, and 0 wt % to 15 wt % of conductive additive, the balance being polymer binder.

One embodiment of the present invention involves preparation of mesh-based sulfur (S) electrodes to be used in Li—S batteries, where elemental S powder is mixed with a conducting additive and a polymer binder without presence of a solvent and pressed with or without heat, forming electrode membranes, a pair of which, sandwiching a mesh, may be pressed partially into the pores of the metal mesh substrate under pressure and heat, forming mesh-based S electrodes without using any solvents. The relative proportions of sulfur, conductive additive, and polymer binder may range, for example, from 40 wt % to 90 wt % of sulfur, and 10 wt % to 50 wt % of conductive additive, the balance being polymer binder.

It is important to note that there are many factors having impacts on the solvent-free preparation of mesh-based electrodes, including material particle size, heat-press temperature, pressure, and time, and materials feeding rate into the pair of rollers. While it is difficult to provide a general guidance to determine optimal values of these factors, the followings are worth noting.

It is noted that the size of the particles of the ceramic materials including lithium metal oxides, graphite, and conductive carbons, must be significantly smaller than the pore size of the metal mesh, permitting these particles to squeeze into the pores along with the polymer binder, in an effort to form an integral, fine mesh reinforced composite of energy storage electrodes. It is also noted that the heat-pressing temperature should be sufficiently high to allow polymer binders to infiltrate into the voids of the mixture or to form a coated layer on the particles when heat-pressing. Therefore the heat-pressing temperature must be higher than the glass transition temperature (T_{g}), or preferably higher than the melting point (Tₘ) of the polymer. These temperatures, along with sufficiently high values of pressures, are critical for inherently bonding between the particles and between the two membranes within the mesh pore structures.

It is also noted that a single membrane may be used in preparation of the mesh-based electrode by heat-pressing with the mesh; however, a pair of membranes sandwiching a mesh is preferred as this ensures formation of a uniform, balanced electrode having electrode materials distributed evenly on both sides of the mesh.

It is further noted that when the pressing temperature is above the melting point of the polymer binder, the processes described in FIGS. 3 to 7 are essentially plastic thermoforming. In addition, the electrode materials mixture, along with the mesh substrate, may be directly fed into the heat-press apparatus, forming mesh-based electrodes without the step of making the electrode membranes.

Having generally described the invention, the following examples serve to illustrate the preferred embodiments of the present invention and should not be construed as limiting the scope of the invention:

### EXAMPLE 1

### Preparation of Supercapacitor Electrodes

A sample of well mixed powder consisting of PVDF (20 wt %) and Activated Carbon (80 wt %) is loaded evenly into mold 20A. (FIG. 2) The sample of the mixture is pressed with mold 20B being lowered into mold 20A at 185° C. and 5 psig for an hr. (FIG. 3) The process continues at 200° C. without pressure for another 5 hrs. The molds are cooled to room temperature and disassembled. The electrode membrane (60μ×5 cm×10 cm) is collected from the mold.

A pair of the electrode membranes (60μ×5 cm×10 cm) prepared above, sandwiching an aluminum mesh (6.5 cm×11 cm) with mesh wire thickness of 50μ and pore diameter 50μ, are placed between a pair of hot plates. (FIG. 4) The length of the membranes is aligned along one of the lengths of the mesh. The membrane/mesh assembly is pressed at 215° C. and 5 psig for 5 hrs, followed by cooling to room temperature. The top press plate is lifted, and the resulting mesh-based supercapacitor electrode is removed from the press plate, followed by cleaning off excess materials from the edges of the rectangle mesh substrate using a razor blade.

### EXAMPLE 2

### Preparation of Li-ion Cathodes

A sample of well mixed powder consisting of PVDF (15 wt %), LiFePO₄ (80 wt %) and carbon black (5 wt %) is loaded evenly into mold 20A. (FIG. 2) The sample of the mixture is pressed with mold 20B being lowered into mold 20A at 185° C. and 5 psig for an hr. (FIG. 3) The process continues at 200° C. without pressure for additional 5 hrs. The molds are cooled to room temperature and disassembled. The electrode membrane (60μ×5 cm×10 cm) is collected from the mold.

A pair of the electrode membranes (60μ×5 cm×10 cm) made above, sandwiching an aluminum mesh (6.5 cm×11 cm) with mesh wire thickness of 50μ, and pore diameter 50μ, are placed between a pair of hot plates (FIG. 4). The length of the membranes is aligned along one of the lengths of the mesh. The membrane/mesh assembly is pressed at 215° C. and 8 psig for 5 hrs, followed by cooling to room temperature. The top press plate is lifted, and the resulting mesh-based Li-ion cathode electrode is removed from the press plate, followed by cleaning off excess materials from the edges of the rectangle mesh substrate using a razor blade.

### EXAMPLE 3

### Preparation of Li-ion Anodes

A sample of well mixed powder consisting of PVDF (15 wt %), and graphite (85 wt %) is lowered evenly into mold 20A. (FIG. 2) The sample of the mixture is pressed with mold 20B being loaded into mold 20A at 185° C. and 5 psig for an hr. (FIG. 3) The process continues at 200° C. without pressure for additional 5 hrs. The molds are cooled to room temperature and disassembled. The electrode membrane (60μ×5 cm×10 cm) is collected from the mold.

A pair of the electrode membranes (60μ×5 cm×10 cm) made above, sandwiching a copper mesh (6.5 cm×11 cm) with mesh wire thickness of 50μ and pore diameter 50μ, are placed between a pair of hot plates (FIG. 4). The length of the membranes is aligned along one of the lengths of the mesh. The membrane/mesh assembly is pressed at 215° C. and 8 psig for 5 hrs, followed by cooling to room temperature. The top press plate is lifted, and the resulting mesh-based Li-ion anode electrode is removed from the press plate, followed by cleaning off excess materials from the edges of the rectangle mesh substrate using a razor blade.

### EXAMPLE 4

### Preparation of S Electrodes

A sample of well mixed powder consisting of PVDF (15 wt %), carbon black (35 wt %), and sulfur (50 wt %) is loaded evenly into mold 20A. (FIG. 2) The sample of the mixture is pressed with mold 20B being lowered into mold 20A at 185° C. and 5 psig for an hr. (FIG. 3) The process continues at 200° C. without pressure for additional 5 hrs. The molds are cooled to room temperature and disassembled. The electrode membrane (60μ×5 cm×10 cm) is collected from the mold.

A pair of the electrode membranes (60μ×5 cm×10 cm) made above, sandwiching a A1 mesh (6.5 cm×11 cm) with mesh wire thickness of 50μ and pore diameter 50μ, are placed between a pair of hot plates (FIG. 4). The length of the membranes is aligned along one of the lengths of the mesh. The membrane/mesh assembly is pressed at 215° C. and 8 psig for 5 hrs, followed by cooling to room temperature. The top press plate is lifted, and the resulting mesh-based S electrode is removed from the press plate, followed by cleaning off excess materials from the edges of the rectangle mesh substrate using a razor blade.

What is claimed:

1. A method of making an energy storage electrode comprising:
a) forming an electrode membrane by heat-pressing a mixture of powdery materials consisting of an electrode active material, a conducting additive, and a polymer binder;
b) forming the energy storage electrode by heat-pressing a pair of the electrode membranes sandwiching a metal mesh current collector.

2. The method according to claim 1, wherein said electrode membrane having a thickness ranging from 10 microns to 200 microns.

3. The method according to claim 1, wherein said metal mesh current collector comprising a material selecting from the group consisting of Al, Cu, Ni, Sb, Cr, Fe, and Si.

4. The method according to claim 1, wherein said metal mesh having a wire diameter ranging from 10 microns to 100 microns, and a mesh pore size ranging from 10 microns to 100 microns.

5. The method according to claim 1, wherein said energy storage electrode having a thickness ranging from 20 microns to 200 microns.

6. The method according to claim 1, wherein said energy storage electrode is a Li-ion cathode, and wherein said active material comprising a material selecting from the group consisting of S, LiCoO₂, LiNiO₂, LiMn₂O₄, LiFePO₄, and LiNiₓCo_{y}Mn_{z}, said conductive additive comprising a material selecting from the group consisting of graphite and carbon black, and said polymer binder comprising a material selecting from the group consisting of PVDF, EPDM, CMC, PTFE and SBR.

7. The method according to claim 1, wherein said energy storage electrode is a Li-ion anode, and wherein said active material comprising a material selecting from the group consisting of graphite and silicon, said conductive additive comprising a material selecting from the group consisting of graphite and carbon black, and said polymer binder comprising a material selecting from the group consisting of PVDF, EPDM, CMC, PTFE and SBR.

8. The method according to claim 1, wherein said energy storage electrode is a supercapacitor electrode, and wherein said active material comprising a material selecting from the group consisting of activated carbons, carbon nanotubes, graphenes, RuO₂, NiO, and IrO₂, said conductive additive comprising a material selecting from the group consisting of graphite and carbon black, and said polymer binder comprising a material selecting from the group consisting of PVDF, EPDM, CMC, PTFE and SBR.

9. The method according to claim 1, wherein said heat-pressing temperature ranging from 25° C. to 400° C.

10. The method according to claim 1, wherein said heat-pressing pressure ranging from 0 to 65 psig.
